(19) United States
(12) Patent Application Publication
(10) Pub. No.: US 2007/0055391 A1
(43) Pub. Date: Mar. 8, 2007

(54) Method for the automatic adjustment of a busable field device used in a process automation to the bus protocol utilized on the fieldbus

(75) Inventors: Wilhelm Schneider, Fussen (DE); Chrisitan Heim, Zell (DE); Bernd Briechle, Waltenhofen (DE)

Correspondence Address: BACON & THOMAS, PLLC, 625 SLATERS LANE, FOURTH FLOOR, ALEXANDRIA, VA, 22314, US

(73) Assignee: ENDRESSWETZER GMBH+CO. KG, Nesselwang (DE)

(21) Appl. No.: 10/566,756

(22) PCT Filed: Jul. 16, 2004
(86) PCT No.: PCT/EP04/07979

§ 371 Date: Aug. 22, 2006

(30) Foreign Application Priority Data
Aug. 1, 2003 (DE) 103 360 35.2

(51) Int. Cl. G05B 13/02

(52) U.S. Cl. 700/28; 710/305

(57) ABSTRACT

In a method for automatically adjusting a bus-capable field device of process automation technology to the bus protocol utilized on the fieldbus, fieldbus telegrams are relayed to various fieldbus stacks. The fieldbus stack which properly processes the telegrams is selected for exchanging data with the fieldbus.

The invention concerns a method for automatically adjusting a bus-capable field device to the bus protocol utilized on the fieldbus.

In the field of process automation technology, a wide variety of field devices are used which serve to register and/or influence process variables. Examples of such field devices are fill level measuring devices, mass-flow measuring devices, pressure and temperature measuring devices, pH-redox potential measuring devices, conductivity measuring devices, etc., which, as sensors, register the corresponding process variables fill level, flow rate, pressure, temperature, pH-value, or conductivity value.

Besides such measuring devices, systems are also known which fulfill further tasks in addition to only registering measured values. Here, for instance, especially electrode cleaning systems, calibration systems, as well as samplers are meant. Likewise, input/output units—so-called “remote I/Os”—are also characterized as field devices.

Serving for influencing process variables are actuators, which e.g. as valves, control the flow rate of a fluid at a section of piping, or which, as pumps, alter the fill level in a container.

The firm Endress+Hauser produces and sells a wide variety of such field devices.

Frequently, field devices are connected with fieldbus systems (Profibus, Foundation Fieldbus, etc.), which enable a digital exchange of data between the field devices and superordinated units, e.g. control systems or control units. These superordinated units serve mainly to control and monitor the process.

For process control and monitoring, it is of utmost importance that the data exchange via the field bus system occurs in a secure and reliable manner. Data is exchanged via the fieldbus in the form of telegrams (frames) which have a very specific construction dictated by the bus protocol used. In accordance with the respective bus protocol, the wanted data are packed into a row of control and check sequences.

In the case of contemporary field bus systems, different bus protocols are used. Very common field bus systems in the world of process automation are Profibus PA and Foundation Fieldbus H1. The protocol (data link layer) from Profibus PA is described more closely in the standard EN50170. The Foundation Fieldbus specifications are summarized in “Foundation Fieldbus Technical Specifications,” which is available to the public.

Already at the time of production of the field devices, these must be adjusted to the respective field bus system. For this, an appropriate field bus stack program is implemented in the field device. A task of the fieldbus stack program is to extract the wanted data from the telegrams sent via the fieldbus, and to relay such to the respective application running in the field device for further processing. Stacks for the different fieldbus systems are provided e.g. by the firms TMG-itec or Softing AG. The memory requirement for a Profibus PA stack is around 50 kB, and for a Foundation Fieldbus FF-stack is at 250 kB.

If a specific field bus stack, e.g. a Profibus-stack, is implemented in a field device, then this field device can be used only in a Profibus fieldbus system; use in a Foundation Fieldbus field bus system, or other systems, is not possible. For the producer of field devices, this means a complex and cost-intensive production, because different production lines for field devices with different fieldbus-stacks are required.

Also on the user-side, problems arise due to the plurality of the possible fieldbus systems. Present field devices cannot be used with a different bus.

Due to the required expenditure, a change from one fieldbus system to another is practically impossible.

Therefore, from the state of the art, different methods for adjusting field devices to fieldbus systems are already known. These methods, known from the documents DE 198 47 701 and WO 03/039098, analyze in each case the telegrams which are sent via the fieldbus, according to specific characteristic properties for the respective protocol. For this, the fieldbus protocols must be extensively examined at the front end according to characteristic properties, and these characteristic properties are converted into programs with corresponding scanning routines, which must then be stored in the field devices.

These methods are normally only suited for two predetermined fieldbus protocols. The adjusting of these methods to a new bus protocol is relatively complex.

An object of the present invention is therefore to provide a method for the automatic adjustment of a bus-capable field device of process automation technology to the protocol utilized on the fieldbus, which method is simple and cost-efficient to execute, and which in principle, is suitable for any protocol.

This object is achieved by the method defined in claim 1.

Advantageous further developments of the invention are presented in the dependent claims.

An essential idea of the invention is to receive telegrams from a fieldbus, and to relay such to various fieldbus stacks stored in the field device, and to process the telegrams in these fieldbus stacks. That fieldbus stack is selected which can properly process the telegrams, that is, with which further-processable, wanted data can be extracted from the telegrams. Further data exchange with the fieldbus occurs with this selected fieldbus stack. In this way, it is possible to easily adjust a bus-capable field device to the protocol utilized on the field bus.

The invention will now be described in greater detail on the basis of an example of an embodiment illustrated in the drawing, the figures of which show as follows:

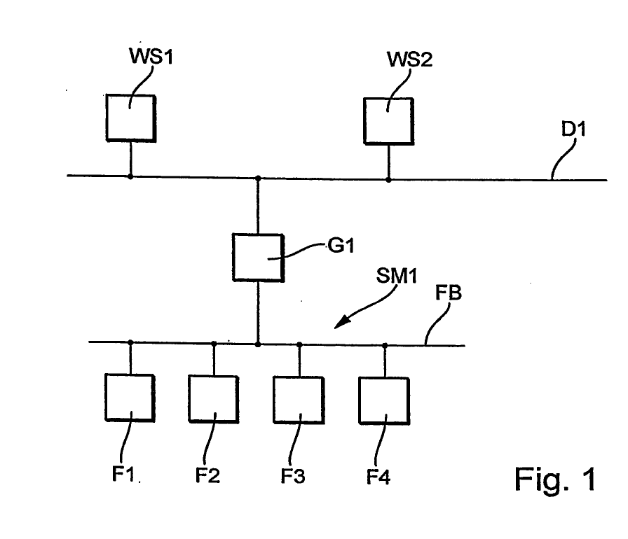

FIG. 1 schematic illustration of a fieldbus system of process automation technology;

FIG. 2 bus-capable field device;

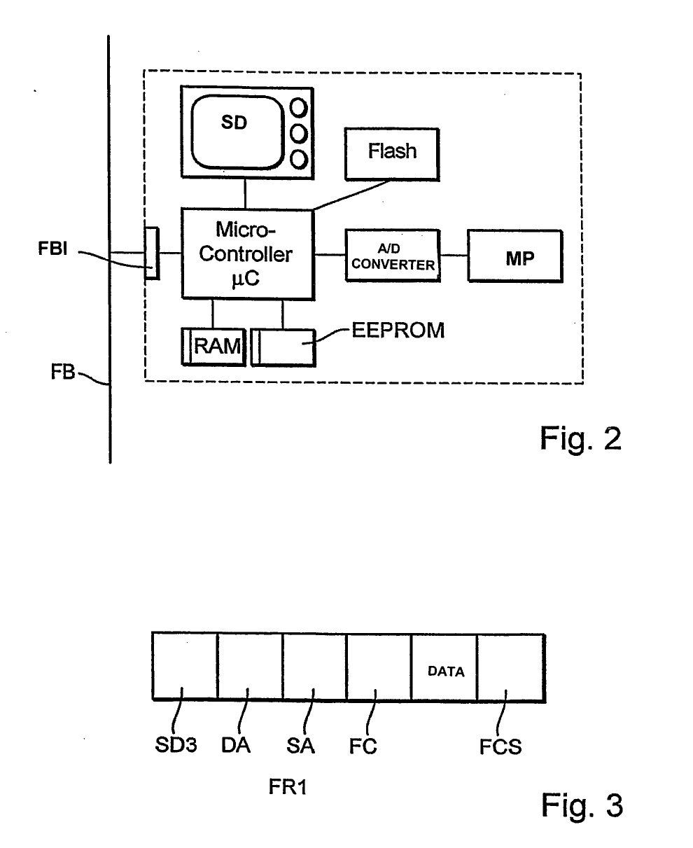

FIG. 3 construction of a fieldbus telegram;

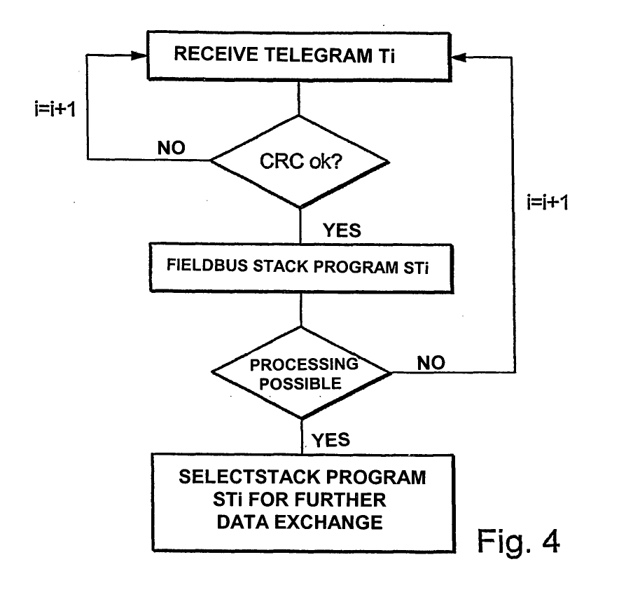

FIG. 4 flow diagram of the method of the invention.

FIG. 1 shows in greater detail a fieldbus system of process automation technology, which system operates according to the Foundation Fieldbus standard. Multiple control systems, or control units (workstations) WS1, WS2, which serve for process visualization, process monitoring, and engineering, are connected to a data bus D1. Data bus D1 operates according to the Foundation Fieldbus HSE (high speed Ethernet) standard. Via a gateway G1, which can also be called a linking device, data bus D1 is connected with a fieldbus segment SM1. The fieldbus segment SM1 is composed of multiple field devices F1, F2, F3, F4, which are connected with one another via a fieldbus FB. The fieldbus FB also operates in accordance with the Foundation Fieldbus standard.

FIG. 2 shows field device F1 in greater detail. In this example, the field device is a temperature transmitter with sensor. The field device F1 has a microcontroller μC, which, via an analog-digital converter A/D, is connected to a measurement pickup MP. For servicing the field device and for displaying various information, an optional service/display unit SD is likewise connected to the microcontroller μC.

As memory for programs and parameters, Flash-, EEPROM, and/or RAM-memory can be used. The microcontroller μC is connected with the fieldbus FB via a fieldbus interface FBI. Via the fieldbus FB, fieldbus telegrams can be exchanged between the field devices and the superordinated units WS1 and/or WS2.

FIG. 3 shows, by way of example, the structure of a telegram based on a Profibus frame FR1. The Profibus frame FR1 is composed of multiple data fields: start field SD3, destination address DA, sender address SA, function code FC, data, and frame-checksum FCS. The data field Data can contain e.g. measurement values, queries, etc.

The method of the invention will now be described in greater detail on the basis of the flow diagram illustrated in FIG. 4.

Field device F1 receives a telegram T1, which is structured according to Foundation Fieldbus rules. In addition to the wanted data, the telegram T1 contains a series of control and check sequences corresponding to the utilized fieldbus telegram (in this case Foundation Fieldbus). Following a successful CRC-check, this fieldbus telegram T1 is relayed by the fieldbus interface FBI to the fieldbus stack program ST1. The fieldbus stack program ST1 is a Profibus stack program. Since the telegram T1 is structured according to Foundation Fieldbus rules, wanted data cannot be extracted from this telegram using the stack program ST1, and thus also cannot be relayed to an application.

The fieldbus stack program ST1 then signals a processing error. Upon this, the stack program ST2 is loaded, and the next telegram T2 sent via the fieldbus FB is received. The telegram T2 is transferred to stack program ST2, and is processed therein. If the stack program ST2 is a Foundation Fieldbus stack program, then wanted data can be extracted from the telegram, and can be relayed to the appropriate application in field device F1. Then, in field device F1, using the wanted data, e.g. diagnostic programs can be started, measurement values can be read out, or parameter values can be altered. If the telegram T2 is correctly processed in fieldbus stack program ST2, then this stack program is used further to read subsequent telegrams, and/or to send telegrams from field device F1 via the fieldbus.

To enable a quick adjustment to the bus protocol used, it makes sense to select the sequence of the fieldbus stack programs ST1, ST2, ST3 according to their degree of use in the world of process automation technology. The stack programs of the most commonly used fieldbus systems should be at the beginning.

In addition to a sequential processing of multiple telegrams in various stack programs, the parallel processing of a telegram in multiple stack programs is also possible. This is only a question of the size of the stack programs and the size of the program memory in the field device. Naturally, a parallel processing enables a faster adjustment to the bus protocol utilized on the field bus.

An essential advantage of the method of the invention is that it can be easily adjusted to new protocols. For this, the appropriate stack program must only be stored in the field device such that telegrams can also be processed therewith.

To those skilled in the art, it is evident that this method can be used not only with fieldbus systems, but also with any communication networks which utilize different network protocols.

1-7. (canceled)

8. A method for automatic adjustment of a bus-capable field device of process automation technology to the fieldbus protocol utilized on a fieldbus, with multiple fieldbus stack programs stored in the field device, which programs serve to extract wanted data from telegrams of various fieldbus systems, comprising the steps of:
receiving telegrams sent via the fieldbus;
transferring the telegrams to the fieldbus stack programs;
processing the telegrams in the fieldbus stack programs; and
selecting a fieldbus stack program for further data exchange with the fieldbus, which program has extracted further processable, wanted data from at least one telegram.

9. The method as claimed in claim 8, wherein:
the received telegrams are transferred successively to the various fieldbus stack programs.

10. The method as claimed in claim 8, wherein:
a telegram is transferred to various fieldbus stack programs.

11. The method as claimed in claim 8, wherein:
at least two fieldbus stack programs are stored in the field device.

12. The method as claimed in claim 11, wherein:
a fieldbus stack program is a Profibus PA stack or a Foundation Fieldbus stack.

13. The method as claimed in claim 8, wherein:
the field device is a temperature sensor.

14. A field device having multiple fieldbus stack programs stored therein, which programs serve to extract wanted data from telegrams of various fieldbus systems, for execution of a method comprising the steps of:
receiving telegrams sent via the fieldbus;
transferring the telegrams to the fieldbus stack programs;
processing the telegrams in the fieldbus stack programs; and
selecting a fieldbus stack program for further data exchange with the fieldbus, which program has extracted further processable, wanted data from at least one telegram.
